(19) United States
(12) Patent Application Publication
(10) Pub. No.: US 2014/0375601 A1
(43) Pub. Date: Dec. 25, 2014

(54) CAPACITIVE TOUCH DEVICE AND DETECTION SYSTEM THEREOF

(71) Applicant: FocalTech Systems, Ltd., George Town (KY)

(72) Inventors: Weiping LIU, Shenzhen (CN); Shaohua FU, Shenzhen (CN); Lianghua MO, Shenzhen (CN)

(21) Appl. No.: 14/303,468

(22) Filed: Jun. 12, 2014

(30) Foreign Application Priority Data
Jun. 24, 2013 (CN) 201310253774.0

(51) Int. Cl. G06F 3/044

(52) U.S. Cl. CPC G06F 3/044
USPC 345/174

(57) ABSTRACT

A detection system for a capacitive touch device including a display device and a capacitive touch screen is provided. A circuit ground of the capacitive touch screen is physically isolated from a system ground of the display device. A capacitive touch device is further provided.

### CROSS REFERENCE TO RELATED APPLICATION

The present application claims the priority to Chinese Patent Application No. 201310253774.0, filed with the Chinese Patent Office on Jun. 24, 2013, entitled as “CAPACITIVE TOUCH DEVICE AND DETECTION SYSTEM THEREOF”, the entire contents of which are incorporated herein by reference.

### TECHNICAL FIELD

The disclosure relates to touch devices, and more particularly to a capacitive touch device and a detection system thereof.

### BACKGROUND

Currently, capacitive touch devices are used widely in various fields, and a complete machine system such as a mobile phone or a computer can achieve touch control via a capacitive touch screen, which facilitates user's operation.

However, a display device such as a Liquid Crystal Display (LCD) near to the capacitive touch screen affects distribution of electric field of the capacitive touch screen. When a heavy load such as a heavy touch occurs on the capacitive touch screen, the distribution of electric field of the capacitive touch screen is heavily affected due to a shortened distance between the display device and the capacitive touch screen. Accordingly, coordinates of the capacitive touch screen and thus detection of the capacitive touch screen are inaccurate and a misjudgment may even happen.

In view of the above, solid material is inserted between the capacitive touch screen and the display device to reduce deformation degree of the capacitive touch screen, so as to reduce the effect on the distribution of electric field of the capacitive touch screen; or the distance between the capacitive touch screen and the display device is increased to reduce change of the electric field due to the heavy load, so as to reduce the effect on the distribution of electric field of the capacitive touch screen. However, these solutions only can reduce the effect on the distribution of electric field of the capacitive touch screen to a limited extent.

### SUMMARY

In view of the above, a capacitive touch device and a detection system thereof are provided according to embodiments of the disclosure.

In a first aspect of the invention, a detection system for a capacitive touch device is provided. The detection system for the capacitive touch device includes a display device and a capacitive touch screen, and a circuit ground of the capacitive touch screen is isolated from a system ground of the display device physically.

In a second aspect of the invention, a capacitive touch device is provided. The capacitive touch device includes the detection system for the capacitive touch device provided in the first second aspect of the invention.

In a third aspect of the invention, a detection system for a capacitive touch device is provided. The detection system for the capacitive touch device includes a display device and a capacitive touch screen, a circuit ground of the capacitive touch screen is connected with a system ground of the display device via a switch, and the switch is switched off when the capacitive touch screen is in a detection operation state.

In a fourth aspect of the invention, a capacitive touch device is provided. The capacitive touch device includes the detection system for the capacitive touch device provided in the third aspect of the disclosure.

### BRIEF DESCRIPTION OF DRAWINGS

In order to illustrate the technical solutions of the embodiments of the disclosure or the prior art more clearly, the accompanying drawings to be used in the description of the embodiments or the prior art are simply described below. Obviously, the accompanying drawing described below are only some embodiments of the disclosure, other accompanying drawings may be obtained by those skilled in the art based on these accompanying drawings without any creative work.

FIG. 1 is a schematic diagram of a detection system for a capacitive touch device according to a first embodiment of the disclosure.

FIG. 2 is a schematic diagram of a detection system for a capacitive touch device according to a second embodiment of the disclosure.

FIG. 3 is a schematic diagram illustrating a time-sharing detection according to the second embodiment of the disclosure.

### DETAILED DESCRIPTION

The detection system for the capacitive touch device and the capacitive touch device according to the embodiments of the disclosure will be described in detail below.

### First Embodiment

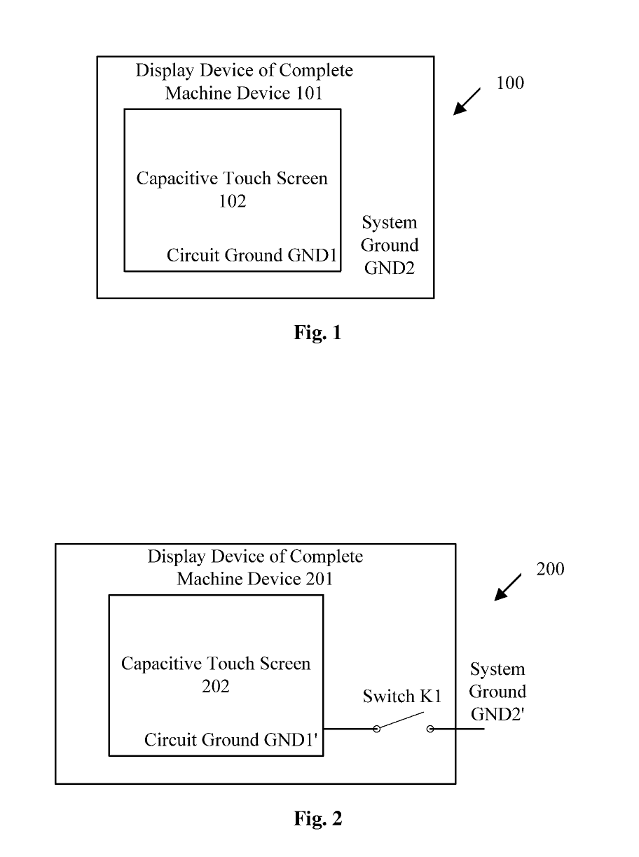

A detection system for a capacitive touch device is provided in this embodiment of the disclosure. As shown in FIG. 1, the detection system 100 for the capacitive touch device includes at least a display device 101 and a capacitive touch screen 102. The capacitive touch screen 102 is attached to the display device 101. The display device 101 may be a display device of a complete machine device such as a mobile phone or a computer. The display device 101 may be an LCD, for example.

Referring to FIG. 1, a circuit ground GND1 of the capacitive touch screen 102 is physically isolated from a system ground GND2 of the display device 101. The circuit ground GND1 indicates a circuit ground of a detection circuit of the capacitive touch screen 102. The system ground GND2 of the display device 101 may be regarded as a system ground of the complete machine device.

Optionally, communication may be performed between the detection circuit of the capacitive touch screen 102 and a control circuit of the display device 101 via magnetic coupling or optical coupling. Magnetic coupling devices or optical coupling devices need not share a common ground when the magnetic coupling devices or the optical coupling device are used to perform communication between the capacitive touch screen 102 and the display device 101. Accordingly, the circuit ground GND1 is not connected to the system ground GND2. In other embodiments, other devices which need not to share a common ground may be adopted to perform the communication between the detection circuit of the capacitive touch screen 102 and the control circuit of the display device 101, which are not described in detail herein.

In view of the above, in the detection system 100 for the capacitive touch device according to the embodiment of the disclosure, the circuit ground GND1 of the capacitive touch screen 102 is isolated from the system ground GND2 of the display device 101. In this case, the display device 101 is a conductor unrelated to the capacitive touch screen 102. Thus the detection circuit of the capacitive touch screen 102 is not affected by interference signals caused by, for example, a heavy load. Therefore, the capacitive touch screen 102 can detect a touch accurately and function normally.

In addition, a noise, which is called as power interference, may be introduced in the system ground GND2 when a poor charger is inserted into the complete machine device. However, the detection circuit is not affected by the noise since the system ground GND2 of the display device 101 is isolated from the circuit ground GND1 of the detection circuit of the capacitive touch screen 102, and the detection result is accurate when a touch occurs.

In addition, since the detection circuit of the capacitive touch screen 102 and the display device 101 do not share a common ground, a current which flows from the display device 101 to the detection circuit can not return to the ground GND2 of the display device 101, i.e., no current flows back through a capacitor between the display device 101 and the capacitive touch screen 102. In this case, a voltage of an electrode on the capacitive touch screen 102 is changed (taking the system ground GND2 as a reference) as the electric level on the display device 101 changes, thus, a voltage difference applied between two sides of the capacitor is not changed, and no electric charge is transferred. Therefore, the detection of the touch screen 102 is not affected by the display device 101.

### Second Embodiment

A detection system for a capacitive touch device is provided in this embodiment of the disclosure. As shown in FIG. 2, the detection system 200 for the capacitive touch device includes at least a display device 201 and a capacitive touch screen 202. The capacitive touch screen 202 is attached to the display device 201. The display device 201 may be a display device of a complete machine device such as a mobile phone or a computer. The display device 201 may be an LCD, for example.

Referring to FIG. 2, a circuit ground GND1′ of the capacitive touch screen 202 is connected to a system ground GND2′ of the display device 201 via a switch K1. The switch K1 is switched off when the capacitive touch screen is in a detection state. That is, the circuit ground GND1′ of the capacitive touch screen 202 is isolated from the system ground GND2′ of the display device 201 when the capacitive touch screen 202 is in the detection state. In the case that the switch K1 is switched off, the technical solution in this embodiment is the same as the technical solution in the first embodiment.

The switch K1 is switched on when detection of the capacitive touch screen 202 is completed. Accordingly, communication can be performed between a detection circuit of the capacitive touch screen 202 and a control circuit of the display device 201. Therefore, communication between the capacitive touch screen 202 and the display device 201 can be achieved without using devices such as magnetic coupling devices or optical coupling devices.

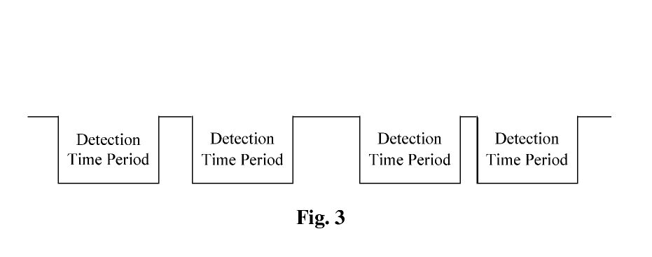

It is easy to be understood that time-sharing detection is adopted in this embodiment, and different operations are performed in different time periods. As shown in FIG. 3, the switch K1 is switched off by a low level, during a detection time period, to ensure that the detection of the capacitive touch screen 202 is not affected by a heavy load. The switch K1 is switched on by a high level, in other time periods after the detection, so that the capacitive touch screen 202 can be charged and perform communication with the complete machine device.

In view of the above, in the detection system 200 for the capacitive touch device provided according to the embodiment of the disclosure, the circuit ground GND1′ of the capacitive touch screen 202 is isolated from the system ground GND2′ of the display device 201 in the detection time period. In this case, the display device 201 is a conductor unrelated to the touch screen 202. Thus the detection circuit of the capacitive touch screen 202 is not affected by interference signals caused by, for example, a heavy load. Therefore, the capacitive touch screen 202 can be detected accurately and function normally.

In addition, a noise, which is called as power interference, may be introduced in the system ground GND2′ when a poor charger is inserted into the complete machine device. However, the detection circuit is not affected by the noise since the system ground GND2′ of the display device 201 is isolated from the circuit ground GND1′ of the detection circuit of the capacitive touch screen 202, and the detection result is accurate when a touch occurs.

In addition, since the detection circuit of the capacitive touch screen 202 and the display device 201 do not share a common ground, a current which flows from the display device 201 to the detection circuit can not return to the ground GND2′ of the display device 201, i.e., no current flows back through a capacitor between the display device 201 and the capacitive touch screen 202. In this case, a voltage of an electrode on the capacitive touch screen 202 is changed (taking the system ground GND2′ as a reference) as the electric level on the display device 201 changes, thus, voltage across two sides of the capacitor is not changed, and no electric charge is transferred. Therefore, the detection of the touch screen 202 is not affected by the display device 201.

### Third Embodiment

A capacitive touch device is provided according to the embodiment of the disclosure.

In one implementation, the capacitive touch device includes the detection system 100 for the capacitive touch device according to the first embodiment.

In another implementation, the capacitive touch device includes the detection system 200 for the capacitive touch device according to the second embodiment.

In the capacitive touch device including the detection system 100 (200) for the capacitive touch device according to the embodiment of the disclosure, the circuit ground GND1 (GND1′) of the capacitive touch screen 102 (202) is isolated from the system ground GND2 (GND2′) of the display device 101 (201) in the detection time period. In this case, the display device 101 (201) is a conductor unrelated to the touch screen 102 (202). Thus the detection circuit of the capacitive touch screen 102 (202) is not affected by interference signals caused by, for example, a heavy load. Therefore, the capacitive touch screen 102 (202) can be detected accurately and function normally.

It should be understood by those skilled in the art that part or all of the procedures in the above-mentioned method embodiments may be implemented by hardware or hardware related to program instructions. The program may be stored in a computer readable storage medium. The storage medium may include a Read Only Memory, a Random Access memory, a disk, a Compact Disk, etc.

Detail description is given to the capacitive touch device and the detection system thereof according to the embodiments of the disclosure. The explanation for the embodiments is used to help in understanding the method and the core idea of the disclosure and should not limit the disclosure. Changes and replacements in the technical scope of the disclosure which can be easily obtained by those skilled in the art fall within the scope of protection of the invention.

1. A detection system for a capacitive touch device, comprising a display device and a capacitive touch screen, wherein a circuit ground of the capacitive touch screen is physically isolated from a system ground of the display device.

2. The system according to claim 1, wherein
a detection circuit of the capacitive touch screen and a control circuit of the display device communicate with each other via magnetic coupling or optical coupling.

3. A capacitive touch device, comprising a detection system for the capacitive touch device, wherein the detection system for the capacitive touch device comprises a display device and a capacitive touch screen, and a circuit ground of the capacitive touch screen is isolated from a system ground of the display device physically.

4. The capacitive touch device according to claim 3, wherein
a detection circuit of the capacitive touch screen and a control circuit of the display device communicate with each other via magnetic coupling or optical coupling.

5. A detection system for a capacitive touch device, comprising a display device and a capacitive touch screen, wherein a circuit ground of the capacitive touch screen is connected to a system ground of the display device via a switch, and the switch is switched off when the capacitive touch screen is in a detection operation state.

6. The system according to claim 5, wherein
the switch is switched on when the capacitive touch screen completes touch detection, and a detection circuit of the capacitive touch screen communicates with a control circuit of the display device when the switch is switched on.

7. A capacitive touch device, comprising a detection system for the capacitive touch device, wherein the detection system for the capacitive touch device comprises a display device and a capacitive touch screen, and a circuit ground of the capacitive touch screen is connected with a system ground of the display device via a switch, and the switch is switched off when the capacitive touch screen is in a detection operation state.

8. The system according to claim 7, wherein
the switch is switched on when the capacitive touch screen completes touch detection, a detection circuit of the capacitive touch screen communicates with a control circuit of the display device when the switch is switched on.
